(19) United States
(12) Patent Application Publication
(10) Pub. No.: US 2026/0155894 A1
(43) Pub. Date: Jun. 4, 2026

(54) FREE SPACE OPTICS COHERENT RECEIVER ARCHITECTURE USING OPTICAL INJECTION LOCKING

(71) Applicant: General Dynamics Mission Systems, Inc., Fairfax, VA (US)

(72) Inventors: Juan C. Juarez, Ellicott City, MD (US); Claudia Ann Gamble, Annapolis, MD (US); Matthew L. Heston, Arnold, MD (US)

(73) Assignee: General Dynamics Mission Systems, Inc., Fairfax, VA (US)

(21) Appl. No.: 18/953,909

(22) Filed: Nov. 20, 2024

(51) Int. Cl. H04B 10/61; H04B 10/112; H04B 10/63

(52) U.S. Cl. CPC H04B 10/613; H04B 10/63; H04B 10/1129

(57) ABSTRACT

A method for controlling a free space optical receiver including receiving an optical signal including a digital information by an optical terminal, detecting a phase and an amplitude of the optical signal, generating an optical local oscillator signal in response to the phase and amplitude, extracting an optical baseband signal in response to a superposition of the optical signal and the optical local oscillator signal, converting, by a photodiode, the optical baseband signal into a digital baseband signal, and extracting, by a digital signal processor, the digital information from the digital baseband signal.

### TECHNICAL FIELD

The technical field relates generally to free space optical communication systems and more particularly relates to methods and apparatus for providing a free space optics (FSO) coherent receiver architecture using optical injection locking in a homodyne coherent receiver.

### BACKGROUND

Commercially available 100G and higher rate transponders, optimized for the controlled environment of fiber optic deployments, present unique challenges when implemented in terrestrial FSO applications. While their high bandwidth is attractive for data-intensive transmission, their performance hinges on a crucial assumption: consistent signal strength. Terrestrial FSO links, however, are subject to the challenges of atmospherically induced effects, particularly scintillation. Scintillation describes rapid fluctuations in signal intensity caused by atmospheric turbulence, inducing unpredictable fades that can significantly impact link performance.

These intensity fades pose a significant threat to the reliable operation of commercially designed transponders. Optimized for the stable signal strength inherent to fiber optic systems, these transceivers often exhibit a minimum required receiver sensitivity level to maintain data lock. When the received signal falls below this threshold, a condition commonly referred to as “loss of link” occurs. The weakened signal strength renders the data undecodable by the receiver, resulting in dropped connections, data errors, and ultimately, compromised performance of the high-speed terrestrial FSO link. In addition, when receivers have a loss of link and then the link comes back up, there is a “reacquisition time” for the receiver before it is functional again. The reacquisition time can be many 10's to 100's of milliseconds for the DSP functions to start up, which can be longer than the duration of a fade. When this occurs, you can get into a cycle where the link never comes back up because an additional fade occurs before the reset has completed, restarting the cycle. This can be very problematic for FSO systems.

To mitigate these limitations and ensure reliable data transmission in terrestrial applications, forward error correction (FEC) techniques are typically incorporated into the transceiver design to bolster its resilience against data errors induced by scintillation fades. Alternatively, employing higher-margin transponders with inherently superior receiver sensitivity or using alternative error correction schemes such as block coding or interleaving specifically designed to handle the effects of atmospheric turbulence have been used to address the problem.

The development of high-performance coherent receivers for free-space and fiber optic communication systems presents significant engineering hurdles. These systems demand real-time implementation of complex digital signal processing (DSP) algorithms for tasks like signal clock synchronization, carrier recovery, and demodulation. Unfortunately, commercially available electronics, such as FPGAs, often lack the processing power and specialized features required for these computationally intensive operations when operating at very high data rates. This necessitates the development of custom-designed, high-speed electronic components including application-specific integrated circuits (ASICs). These circuits can handle the intricate processing and high data rates encountered in coherent receivers. Custom electronics are typically more expensive to manufacture than their commercial counterparts. Additionally, the power demands of these high-speed circuits can be significant, requiring careful thermal management strategies to ensure reliable operation. Typically, the pursuit of high-performance in custom coherent receivers necessitates a trade-off. While custom electronics offer the processing muscle needed for complex DSP tasks, they come with a price tag in terms of cost and power consumption. This is an ongoing challenge in the field of optical communications. As such, it is desirable to address these problems and provide a robust solution for FSO coherent receivers or other optical applications. In addition, other desirable features and characteristics will become apparent from the subsequent summary and detailed description, and the appended claims, taken in conjunction with the accompanying drawings and this background.

### SUMMARY

Disclosed herein are communications systems, communication algorithms, sensors, transmitters and receivers, and related control logic for provisioning control systems employing FSO coherent receiver architecture, methods for making and methods for operating such systems, and other systems equipped with such transmitters, receivers, and controllers. By way of example, and not limitation, there is presented method and apparatus for providing an optical local oscillator signal derived in response to a detected phase and frequency of a received optical signal.

In accordance with an exemplary embodiment, a method for controlling a free space optical receiver including receiving an optical signal including a digital information by an optical terminal, detecting, by a first photodiode, a phase and a frequency of the optical signal, generating, by a laser diode, an optical local oscillator signal in response to the phase and the frequency, extracting, by a quadrature optical hybrid, an optical baseband signal in response to a superposition of the optical signal and the optical local oscillator signal, converting, by a second photodiode, the optical baseband signal into a digital baseband signal, and extracting, by a digital signal processor, the digital information from the digital baseband signal.

In accordance with another exemplary embodiment, a free space optical receiver including an optical terminal configured for receiving an optical signal including a digital information, a photodetector configured for detecting a phase and a frequency of the optical signal, a laser diode configured for generating an optical local oscillator signal in response to the phase and the frequency, a quadrature optical hybrid configured for extracting an optical baseband signal in response to a superposition of the optical signal and the optical local oscillator signal, converting, by a photodiode, the optical baseband signal into a digital baseband signal, and extracting, by a digital signal processor, the digital information from the digital baseband signal.

In accordance with another exemplary embodiment, a communications receiver including an optical terminal for receiving an optical signal transmitted within a free space environment wherein the optical signal includes a data packet, an optical signal conditioner including an optical amplifier, an optical bandpass filter, and an optical attenuator for generating a conditioned optical signal, an optical splitter for dividing the conditioned optical signal into a first conditioned optical signal and a second conditioned optical signal, a laser diode configured for generating an optical local oscillator signal in response to the phase and the frequency of the incoming signal, a ninety-degree optical hybrid configured for extracting an optical baseband signal in response to a superposition of the first conditioned optical signal and the optical local oscillator signal, a photodiode configured for converting the optical baseband signal into a digital baseband signal, and a digital signal processor configured for extracting the data packet from the digital baseband signal.

Other objects, advantages and novel features of the exemplary embodiments will become more apparent from the following detailed description of exemplary embodiments and the accompanying drawings.

### BRIEF DESCRIPTION OF DRAWINGS

The above-mentioned and other features and advantages of this invention, and the manner of attaining them, will become more apparent and the system and method will be better understood by reference to the following description of embodiments of the invention taken in conjunction with the accompanying drawings.

FIG. 1 illustrates a block diagram illustrative of an exemplary FSO transceiver for use with optical injection locking according to an exemplary embodiment of the present disclosure.

FIG. 2 illustrates a block diagram illustrative of an exemplary FSO receiver for use with optical injection locking according to an exemplary embodiment of the present disclosure.

FIG. 3 shows a flow diagram illustrating a non-limiting embodiment of exemplary method for controlling a waveplate configuration using an endless optical polarization control algorithm condition according to an exemplary embodiment.

The exemplifications set out herein illustrate preferred embodiments of the invention, and such exemplifications are not to be construed as limiting the scope of the invention in any manner.

### DETAILED DESCRIPTION

The following detailed description is merely exemplary in nature and is not intended to limit the invention or the application and uses of the invention. Furthermore, there is no intention to be bound by any theory presented in the preceding background or the following detailed description. Various non-limiting embodiments of free space optical receivers, free space optical receiver control algorithms, and software are provided. In general, the disclosure herein describes a free space optical receiver employing a homodyne scheme for coherent detection in the free space optical receiver.

In the realm of optical communication, free-space optical (FSO) receivers are used for establishing high-bandwidth, secure links. Within an FSO communication system, the receiver plays a critical role. Effective FSO receiver design necessitates meticulous consideration of several parameters including light frequency, optical terminal directivity, and received signal conditioning. High-quality optical components are critical, with lenses playing a vital role in focusing the received light into a single mode fiber to be routed to the optical signal conditioning subsystem prior to being sent to the receiver. Additionally, optical filters are often employed to mitigate background noise and enhance signal fidelity. Active tracking mechanisms are also implemented to ensure perfect alignment between the receiver and the incoming beam. In some exemplary FSO systems, the optical terminal or aperture focuses light into a single mode fiber. This fiber routes the optical signal to the optical receiver.

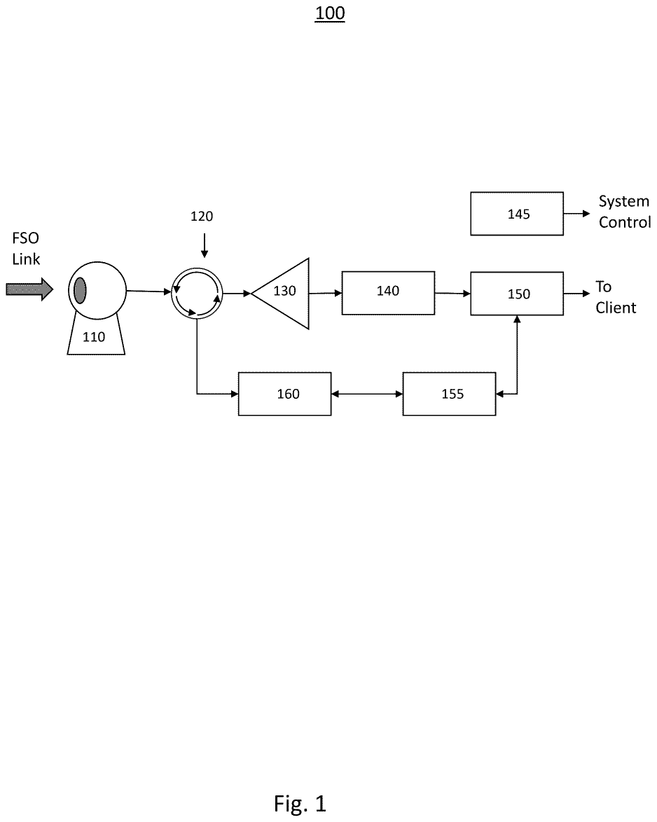

Turning now to FIG. 1, a block diagram illustrative of an exemplary FSO transceiver 100 for use with optical injection locking according to an exemplary embodiment of the present disclosure is shown. The exemplary transceiver 100 includes an optical terminal 110, optical circulator 120, transmit amplifier 130, transmitter 140, digital modem 150, controller 145, coherent receiver 155 and receiver optical signal conditioner 160. The transceiver 100 is configured as a full-duplex communication node, leveraging lasers to establish high-bandwidth data links through the transmission and reception of light beams across free space. The transmitter 140 converts the outgoing data signals unto the optical carrier. The receiver 155 converts the incoming optical signal into a usable electrical format for further digital signal processing. FSO transceivers are typically used where traditional fiber optic infrastructure is infeasible.

In an FSO transceiver, the optical terminal 110 serves as an interface between the free space and the fiber optic circuitry. For the receiver function, the optical terminal 110 collects the free space optical signal and focuses into a single mode fiber, which then connects to the optical circulator 120. The resulting signal is then fed into downstream optical components for signal conditioning, receiver tuning, baseband optical signal detection and data extraction. In the transmitter function, the optical terminal 110 prepares the data signal to be transmitted through free space by converting it into a collimated light beam and ensuring precise alignment and pointing of the outgoing beam towards the receiving terminal. This alignment of the light beam ensures it reaches its intended target with minimal loss, particularly crucial for long-range FSO communication links. In some exemplary embodiments, the optical terminal 110 can employ an optical collection assembly, typically a telescope or high-performance lens, to gather the collimated light beam transmitted from a distant source. Since atmospheric turbulence and misalignment can significantly attenuate the signal, high-precision optical components are required. To maintain a robust connection, the optical terminal 110 can employ active tracking such with gimbals or steerable mirrors that dynamically adjust based on real-time feedback from a tracking sensor. This active tracking ensures the incoming laser remains precisely focused on a dedicated detector within the optical terminal 110.

Following capture of the incoming laser, the optical terminal 110 can further process the receive optical signal for signal filtering and amplification. Specialized optical filters tuned to the specific wavelength of the transmitted laser effectively remove unwanted light, enhancing the desired signal. To further bolster the often-weak signal, optical amplifiers can be employed. These would be included in the optical signal conditioning block 160. These amplifiers significantly boost the strength of the received signal before conversion. The conditioned optical signal must then be converted to a usable electrical format for further processing and data transmission. In a homodyne receiver, this function is performed by overlaying an optical local oscillator signal onto the conditioned receive optical signal, the optical local oscillator signal having the same frequency and phase as the conditioned optical signal resulting in a baseband optical signal. The baseband optical signal is then converted to an electrical signal by a photodetector, a device that effectively translates received photons into an electrical current. The magnitude of this current directly correlates to the intensity of the received light.

For data transmission, the transceiver 100 is configured to receive data from a client via the digital modem 150. The digital modem module 150 can manage the higher-level delivery of data packets across the network, from the client to the transceiver 100. The digital modem module 150 employs network transport protocols to manage the data using a standardized framework for network communications. The digital modem module 150 works to ensure reliable and sequenced delivery of data packets between applications residing on disparate devices. Protocols like Transmission Control Protocol (TCP) and User Datagram Protocol (UDP) are examples of software modules governing data transport within the network itself.

In the transmit mode, the transmitter 140 receives data in the form of electrical signals to be transmitted from the digital modem module 150. This data is typically in the form of a specific network standard such as the Ethernet protocol. The data formatting stage can include adding framing overhead to the data packets including control characters for synchronization, error detection, and addressing the receiver to ensure the receiver can properly interpret the incoming light pulses.

In some exemplary embodiments, the transmitter 140 can next convert the formatted electrical data into a format suitable for modulating a light source. This modulation technique manipulates a key property of the light beam, such as its intensity or phase, to encode the digital data. Common modulation schemes include On-Off Keying (OOK), where a laser is switched on and off to represent binary 1s and 0s, and Manchester encoding, which combines data and clock information into the light pulses. The chosen modulation technique significantly impacts data rate, power consumption, and sensitivity to atmospheric conditions. In a coherent transmitter, a common modulation format quadrature phase shift keying (QPSK), where data is encoded into the phase of the optical signal. Finally, the transmitter 140 can be configured to modulate the light signal with the modulated electrical signal. This light beam is then coupled to the optical circulator 120 for coupling to the optical terminal 110 via an amplifier, such as an Erbium-Doped Fiber Amplifier (EDFA) 130.

The EDFA 130 is configured for amplifying the light signal generated by the transmitter 140 at specific wavelengths. This process effectively strengthens the desired light pulses carrying the encoded data. The selective amplification nature of EDFAs is advantageous in FSO systems as they can be configured to amplify light within a narrow wavelength band, typically matching transmission windows through the atmosphere. This selectivity ensures that the EDFA 130 primarily amplifies the signal of interest while minimizing the amplification of any background noise or unwanted light present in the optical signal leading to improved data reception quality and reliable communication over longer distances.

The optical circulator 120, such as a three-port optical circulator, can be a passive, non-reciprocal device used to direct the flow of light within the transceiver 100. The optical circulator 120 involves routing incoming light from any port to the subsequent port in the sequence. For instance, in a three port optical circulator, light injected into port 1 exits through port 2 and light injected into port 2 exits through port 3. In transmit mode, the light is received from the EDFA 130 at a first port of the optical circulator 120 and is coupled to the optical terminal 110 from a second port of the optical circulator 120 for transmission into free space. In receive mode, light received from the optical terminal 110 is received at the second port of the optical circulator 120 and is directed towards the receiver optical signal conditioner 160 from a third port of the optical circulator 120.

The optical signal conditioner 160 is configured to receive the light signal from the optical circulator 120. Within an FSO receiver, the optical signal conditioner 160 is configured to transform a weak light pulse into a useable signal. This conditioned signal then becomes suitable for further downstream processing and data extraction. The optical signal conditioner 160 first addresses the inherent attenuation of the received light signal. Factors like atmospheric conditions, spanning distance, and environmental effects can significantly weaken the light pulses during their propagation through free space. To counteract this attenuation, the conditioner often incorporates a low-noise optical amplifier, such as an EDFA, in extended reach FSO systems. The optical signal conditioner 160 next addresses the issue of spectral selectivity. The received light beam might encompass unwanted background noise or residual light from extraneous sources. To address this, the optical signal conditioner 160 can employ optical filters that isolate the desired wavelength band containing the encoded data. These filters can be either thin-film filters or tunable bandpass filters. Tunable bandpass filters provide flexibility by dynamically adjusting the passband to precisely match the transmission wavelength. Finally, the optical signal conditioner 160 implements optical power control with the use of a component like a variable optical attenuator (VOA). The VOA is driven to adjust the optical signal power to a desired level.

The optical signal conditioner 160 is configured to couple the conditioned optical signal to a coherent receiver 155. Conventional FSO receivers rely on direct detection, which focuses solely on the intensity variations of the received light pulses. Coherent detection, however, offers a more sophisticated approach that leverages both the intensity and phase information of the light wave for superior performance. The coherent receiver 155 is configured to generate a local oscillator (LO) signal to be used for homodyne detection. A combination of the LO and incoming signal results in a baseband signal from which the data can be extracted. For example, optical injection locking (OIL) can be used to extract a frequency locked local oscillator from the incoming data signal to use in the coherent receiver 155 for demodulation, significantly reducing the size, weight, and power (SWAP) of the coherent receiver architecture. Use of the OIL and homodyne detection on the incoming optical signal reduces the need for analog to digital converters (ADCs), polarization demultiplexing, and other power-hungry digital signal processing (DSP) functions and provides for a more compact and less expensive approach for a coherent receiver architecture with high sensitivity. In some exemplary embodiments, the beat signal can be conditioned and digitally demodulated to extract the data.

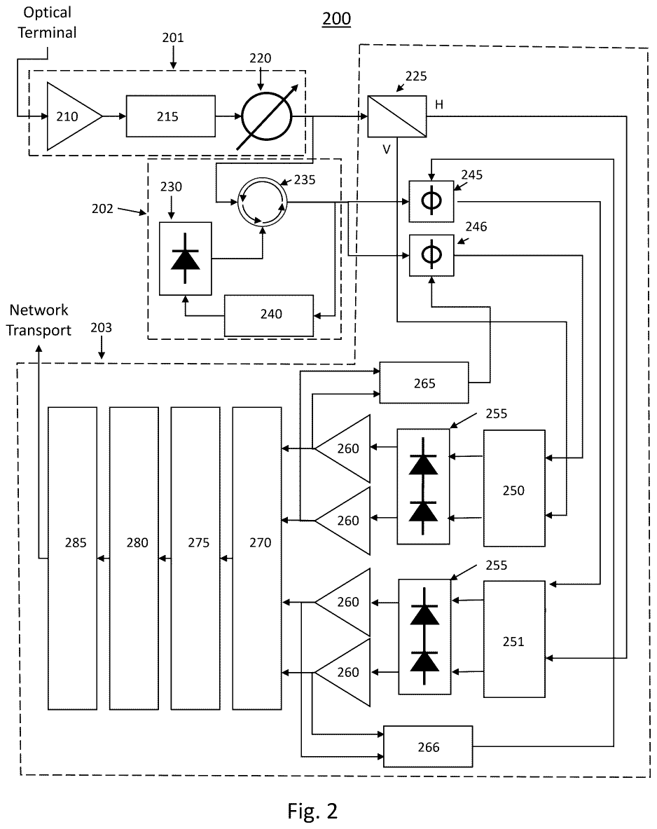

Turning now to FIG. 2, an exemplary configuration for a coherent receiver 200 for use in an FSO coherent receiver architecture using OIL according to an exemplary embodiment is shown. The exemplary coherent receiver 200 can include received optical conditioning module 201, optical injection locking LO recovery module 202 and the coherent receiver module 203.

The received optical conditioning module 201 can include an EDFA 210, bandpass filter 215 and a variable optical attenuator 220. The received optical conditioning module 201 is configured to condition the received laser signal, called the master laser, for further processing by the coherent receiver module 203. The EDFA 210 is an optical amplifier used to boost a light signal at a specific frequency.

The amplified master laser from the EDFA 210 is next coupled to the bandpass filter 215. The bandpass filter 215 is configured to select a predetermined range of wavelengths from the incoming light signal. All other wavelengths experience significant attenuation, essentially blocking their passage. By exerting precise control over the spectral content that travels within the optical circuit, the bandpass filter 215 can be employed for demultiplexing data channels carrying information on separate wavelengths, ensuring only the desired signal reaches a detector, or rejecting unwanted background noise that could compromise signal integrity. The variable optical attenuator 220 is a device that controls the optical signal intensity by adjusting attenuation. The conditioned master laser is next coupled from the received optical conditioning module 201 to both the optical injection locking LO recovery module 202 and the coherent receiver module 203. In the optical injection locking LO recovery module 203, the incoming master laser is coupled to a first port of a circulator 235 and is coupled to an OIL feedback controller 240 from a second port of the circulator 235. The OIL feedback controller 240 is configured to continuously measure key parameters of both the master and slave lasers, such as output power, frequency, and phase. The OIL feedback controller 240 adjusts the injection power, frequency, and phase of the light from the master laser into the slave laser to optimize the locking conditions and maintains the locked state of the slave laser by implementing feedback mechanisms to counteract any disturbances or fluctuations. The OIL feedback controller 240 controls the laser diode 230 in response to the detected parameters of the conditioned master laser in order to synchronize the frequency and phase of the slave laser generated by the laser diode 210. The slave laser is adapted to mimic phase and frequency properties of the master laser through a phenomenon called stimulated emissions. The slave laser is then coupled from the laser diode 230 back to the circulator 235 and then on to the coherent receiver module 203.

The coherent receiver module 203 is configured to receive the master laser from the received optical conditioning module 201 and the slave laser from the optical injection locking LO recovery module 202. The master laser from the received optical conditioning module 201 is coupled to a polarizing beam splitter 225. The polarizing beam splitter 225 is configured to divide the incoming light beam into two separate beams based on the polarization of the light. One beam contains the horizontally polarized component of the light, which is coupled to a first 90 degree hybrid 251, while the other carries the vertically polarized component which is coupled to a second 90 degree hybrid 250. The first and second 90 degree hybrids 250, 251 are configured to split the incoming input optical signals into two output ports with a 90 degree phase difference between them. The slave laser at the OIL-recovered LO frequency and phase from the optical injection locking LO recovery module 202 is coupled to a first phase controller 245 and a second phase controller 246. Individually phase adjusted slave lasers are then coupled from the first and second phase controllers 245 to the first and second 90 degree hybrids 250, 251.

The first and second 90 degree hybrids 250, 251 are configured to combine their respective polarized master laser signal and phase adjusted slave laser signal into two output signals with a 90 degree phase difference between them. Due to the interference between the master laser and the slave laser, a beat frequency can be generated, which is equal to the difference in frequency between the two waves. At this point, the output signals then consist of a DC amplitude component and an AC component carrying the information modulated onto the optical carrier. Advantageously, the two input signals are combined while maintaining high isolation between the ports. These optical output signals are coupled to photodiodes 255, 256, or light detection diodes (LDD) for detection of the optical signals and to generate a corresponding electrical signal. These resultant electrical signals represent the information modulated onto the optical carrier. These electrical signals can then be amplified by a Transimpedance Amplifier (TIA) 260. The output signals of the TIAs 260 are then coupled to digital signal processing circuitry to perform de-skewing 270, resampling and timing recovery 275, equalization 280 and digital demodulation 285. The output of the digital signal processing circuitry is then coupled to the digital modem module for transmission of the extracted data. In addition, the output signals of the TIAs 260 are also coupled to radio frequency beat detectors 255, 256. The outputs of the radio frequency beat detectors 255, 256 are output back to the first phase controller 245 and the second phase controller 246 to adjust the phase of the corresponding phase adjusted slave lasers.

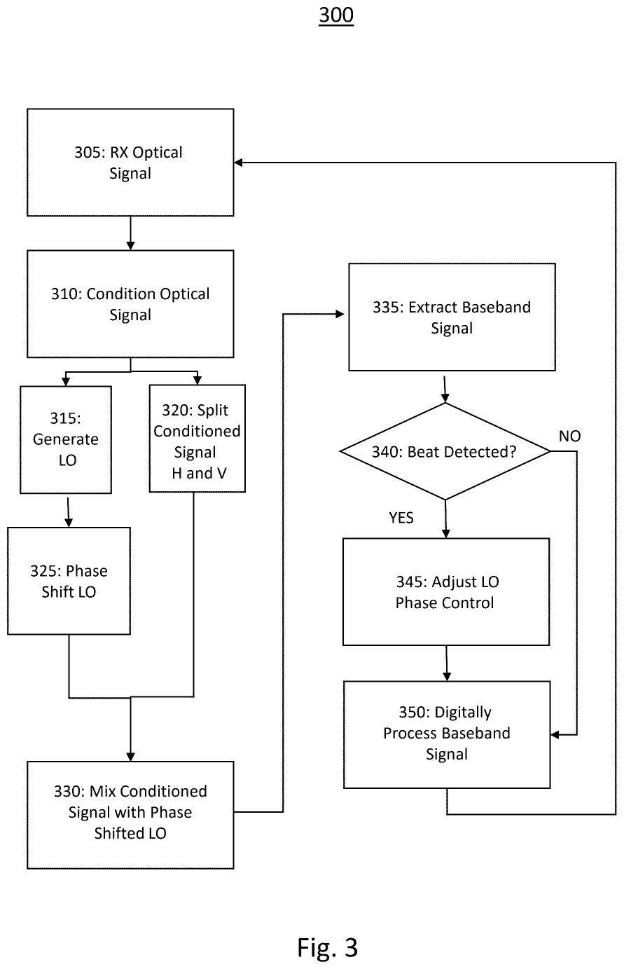

Turning now to FIG. 3, an exemplary method 300 for controlling a coherent receiver for use in an FSO coherent receiver architecture using OIL according to an exemplary embodiment is shown. The exemplary method 300 is first operative to receive an optical signal from free space. The optical signal can be received by an optical terminal or the like. In an FSO receiver, the optical terminal is configured to capture and focus incoming light signals. The optical terminal can include an optical aperture which is the opening through which the incoming light enters the receiver. The optical aperture can include a lens and/or a mirror system designed to maximize light collection while minimizing background noise. The size of the aperture can partially determine the receiver's sensitivity and field of view. The optical terminal can further include a focusing lens for concentrating the incoming light onto a small area, increasing the light intensity. The focal length of the lens partially determine the size of the focused spot and the receiver's sensitivity. In addition, the optical terminal can include a beam steering mechanism for adjusting the optical terminals alignment with the incoming light beam, compensating for atmospheric turbulence or pointing errors.

The method is next operative to condition 310 the received optical signal. In some exemplary embodiments conditioning can include amplification and filtering. When light signals are transmitted through the atmosphere, they can be attenuated due to absorption, scattering, turbulence and scintillation fades. Amplification boosts the signal strength to compensate for these losses and to maintain a reliable data transmission link. Atmospheric conditions, such as fog, rain, and dust, attenuate the optical signal. Filtering removes unwanted noise components, improving optical signal-to-noise ratio (OSNR) and data quality by selectively transmitting specific wavelengths of light while blocking others. OSNR is a key performance metric for optical communication systems. A higher OSNR leads to better error rates and overall system performance.

After conditioning, the method is next operative to generate 315 a local oscillator signal using the received, conditioned optical signal. In accordance with some exemplary embodiments, the local oscillator signal is generated using optical LO recovery. Optical LO recovery involves generating an LO carrier with the same frequency and phase characteristics as the received optical signal. This is achieved by using a controller and a laser diode. In some exemplary embodiments, a portion of the received optical signal is converted into an electrical signal using a high-speed photodetector. This electrical signal contains information about the optical carrier frequency and phase. The electrical signal is then amplified and filtered to remove noise and unwanted components. It is then conditioned to extract the necessary information for LO generation. A PLL (Phase-Locked Loop) can then be used to generate a stable reference clock. The PLL can be used to compare the phase of the recovered carrier signal with the reference clock and generates an error signal. The error signal is fed to a controller that drives a laser diode. The controller adjusts the laser diode's current or temperature to match its output frequency and phase to the recovered carrier signal. The laser diode emits an optical signal that serves as the LO.

While generating the LO, the method is also operative to split 320 the conditioned signal into a horizontal and vertical component. This splitting can be performed by a polarized beam splitter, or the like, to divide the conditioned signal into two separate light signals in response to the polarization of the light. The LO signal is then split into two light signals with each of the light signals being coupled to individual phase shifters. The method then phase shifts 325 each of the light signals to match the phase of one of the components, either horizontal or vertical, of the conditioned signal.

The method is next operative to mix 330, or combine, each of the phased shifted LOs with their respective polarized conditioned signals. In some exemplary embodiments, this combination can be performed by a 90 degree hybrid. The 90 degree hybrid, also known as a quadrature optical hybrid, is operative to combine the two input signals together and produce output signals with specific phase relationships. In some exemplary embodiments, these output signals can have phase differences of 90 degrees. The interference between the conditioned polarized signal and the phase shifted LO result in the phase shifted signals. These output signals are then coupled to photodetectors for converting the light signals to electrical signals.

The method is next operative to detect 340 if there are any beats in the output signals. Beat generation occurs when the optical signal and the LO interfere at the photodetector in a coherent optical receiver. This interference pattern is used for extracting information encoded on the optical carrier. The superposition of the optical signal and LO produces an electrical current comprising both DC and AC components. The AC component, or beat frequency, corresponds to the difference in frequency between the optical signal and the LO. Homodyne detection involves identical frequencies for the signal and LO, resulting in a zero beat frequency. Thus, if a beat is detected, the method is operative to adjust 345 the LO phase control in response to the beat signal information. Information is directly recovered at baseband. If no beat is detected, or if the beat information has been used to adjust the LO phase control, the method is then operative to digitally process 350 the extracted baseband signal.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those of ordinary skill in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

As used herein, the term processor refers to any hardware, software embodied in a medium, firmware, electronic control component, processing logic, and/or processor device, individually or in any combination, including without limitation: application specific integrated circuit (ASIC), an electronic circuit, a field programmable gate array (FPGA), a processor (shared, dedicated, or group) and memory that executes one or more software or firmware programs, a combinational logic circuit, and/or other suitable components that perform the described algorithms.

It is further noted that the systems and methods may be implemented on various types of data processor environments (e.g., on one or more data processors) which execute instructions (e.g., software instructions) to perform operations disclosed herein. Non-limiting examples include implementation on a single general-purpose computer or workstation, or on a networked system, or in a client-server configuration, or in an application service provider configuration. For example, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein. For example, a computer can be programmed with instructions to perform the various steps of the flowcharts described herein. The software components and/or functionality may be located on a single computer or distributed across multiple computers.

What is claimed is:

1. A method for controlling a free space optical receiver comprising:
receiving an optical signal including a digital information by an optical terminal;
detecting, by a first photodiode, a phase and a frequency of the optical signal;
generating, by a laser diode, an optical local oscillator signal in response to the phase and the frequency;
extracting, by a quadrature optical hybrid, an optical baseband signal in response to a superposition of the optical signal and the optical local oscillator signal;
converting, by a second photodiode, the optical baseband signal into a digital baseband signal; and
extracting, by a digital signal processor, the digital information from the digital baseband signal.

2. The method for controlling a free space optical receiver of claim 1 wherein the optical local oscillator signal is generated in response to a detection of the phase and amplitude of the optical signal by a photodetector, the optical local oscillator signal being generated by the laser diode in response to the phase and the amplitude.

3. The method for controlling a free space optical receiver of claim 1 further including adjusting a local oscillator phase and a local oscillator frequency in response to a detection of beat on the optical baseband signal.

4. The method for controlling a free space optical receiver of claim 1 wherein the free space optical receiver is a homodyne coherent receiver.

5. The method for controlling a free space optical receiver of claim 1 wherein the optical signal includes a horizontal component and a vertical component and wherein the horizontal component and the vertical component are isolated by a polarized beam splitter and wherein the horizontal component is applied to a first quadrature optical hybrid with a first phase shifted optical local oscillator signal and the vertical component is applied to a second quadrature optical hybrid with a second phase shifted optical local oscillator signal and wherein there is a 90 degree phase shift between the first phase shifted optical local oscillator signal and the second phase shifted optical local oscillator signal.

6. The method for controlling a free space optical receiver of claim 1 wherein the optical signal is amplified using an erbium-doped fiber amplifier.

7. The method for controlling a free space optical receiver of claim 1 wherein the optical signal is filtered using at least one fixed or tunable bandpass filter.

8. The method for controlling a free space optical receiver of claim 1 wherein the optical baseband signal is modulated in accordance with at least one coherent modulation format, such as quadrature phase shift keying (QPSK).

9. The method for controlling a free space optical receiver of claim 1 wherein an optical injection locking configuration is used to recover the frequency of the modulated signal to generate an optical local oscillator signal.

10. A free space optical receiver comprising:
an optical terminal configured for receiving an optical signal including a digital information;
a photodetector configured for detecting a phase and a frequency of the optical signal;
a laser diode configured for generating an optical local oscillator signal in response to the phase and the frequency;
a quadrature optical hybrid configured for extracting an optical baseband signal in response to a superposition of the optical signal and the optical local oscillator signal;
converting, by a photodiode, the optical baseband signal into a digital baseband signal; and
extracting, by a digital signal processor, the digital information from the digital baseband signal.

11. The free space optical receiver of claim 10 further including a local oscillator controller
configured to control a local oscillator frequency and a local oscillator phase in response to the phase and the frequency of the modulated optical signal

12. The free space optical receiver of claim 10 wherein the phase of the optical local oscillator signal is the same as the phase of the optical signal when the optical local oscillator and the optical signal are applied to the quadrature optical hybrid.

13. The free space optical receiver of claim 10 wherein the optical signal is filtered using at least one of a fixed or tunable bandpass filter and wherein the optical signal is amplified using an erbium-doped fiber amplifier.

14. The free space optical receiver of claim 10 wherein the optical baseband signal is modulated in accordance with at least one coherent modulation format, such as quadrature phase shift keying (QPSK).

15. The free space optical receiver of claim 10 wherein an optical injection locking configuration is used to recover the frequency of the modulated signal to generate an optical local oscillator signal.

16. The free space optical receiver of claim 10 wherein further including a local oscillator controller configured to adjusting a local oscillator phase and a local oscillator frequency in response to a detection of beat on the optical baseband signal.

17. The free space optical receiver of claim 10 further including a memory and wherein the digital signal processor is operative to store the digital information in the memory.

18. The free space optical receiver of claim 10 further including a network interface for receiving the digital information from the digital signal processor and transmitting the digital information on an electrical communications network.

19. A communications receiver comprising:
an optical terminal for receiving an optical signal transmitted within a free space environment wherein the optical signal includes a data packet;
an optical signal conditioner including an optical amplifier, an optical bandpass filter, and an optical attenuator for generating a conditioned optical signal;
an optical splitter for dividing the conditioned optical signal into a first conditioned optical signal and a second conditioned optical signal;
a laser diode configured for generating an optical local oscillator signal in response to the phase and the frequency of the incoming signal;
a ninety-degree optical hybrid configured for extracting an optical baseband signal in response to a superposition of the first conditioned optical signal and the optical local oscillator signal;
a photodiode configured for converting the optical baseband signal into a digital baseband signal; and
a digital signal processor configured for extracting the data packet from the digital baseband signal.

20. The communications receiver of claim 19 further including a network interface for receiving the data packet from the digital signal processor and transmitting the data packet on an electrical communications network.
